(19) United States
(12) Patent Application Publication
(10) Pub. No.: US 2008/0253221 A1
(43) Pub. Date: Oct. 16, 2008

(54) Cordless Electric Powered Concrete Vibrator

(75) Inventor: Joseph W. Lindley, Paducah, KY (US)

Correspondence Address: BARNES & THORNBURG LLP, 11 SOUTH MERIDIAN, INDIANAPOLIS, IN, 46204, US

(73) Assignee: JLIN CORPORATION

(21) Appl. No.: 12/091,323

(22) PCT Filed: Nov. 17, 2006
(86) PCT No.: PCT/US2006/061028

§ 371 Date: Apr. 24, 2008

Related U.S. Application Data
(60) Provisional application No. 60/738,625, filed on Nov. 21, 2005.

(51) Int. Cl. B01F 11/00

(52) U.S. Cl. 366/128

(57) ABSTRACT

A concrete finishing tool includes a power unit (12, 112, 212), a vibratory head (150, 250), a gearbox (24) and a shaft (152), for transmitting rotary motion from the power unit (12,112,212) to the vibratory head (150,250).

### CROSS REFERENCE TO RELATED APPLICATION

This application claims priority to U.S. Provisional Patent Application Ser. No. 60/738,625 filed on Nov. 21, 2005, the entire disclosure of which is hereby incorporated by reference.

### BACKGROUND

The present disclosure relates to powered concrete vibrators. More specifically, the present disclosure relates to concrete vibrators powered by power tools.

Power tools come in a variety of shapes and sizes and may be used for a variety of purposes. For example, there are concrete-finishing tools (e.g., screeds, edgers, groovers, floats, consolidators) and yard tools (e.g., edgers, hedge trimmers, weed cutters), to name just a few.

Concrete vibrators are powered by rotary power units. Effective vibration of concrete requires sufficient rotary speed to rotate a vibratory element, such as an eccentric, at a rate sufficient to develop vibration sufficient to consolidate concrete.

### SUMMARY

According to the present disclosure, a concrete finishing tool comprises a power tool having a rotating output, a vibratory head including a vibrator case and an eccentric housed for rotation therein. The vibratory head includes an input shaft. The concrete finishing tool further comprises speed increasing means for receiving rotational output from the power tool and rotating the input shaft of the vibratory head at a speed greater than the rotational output of the power tool to cause the eccentric to rotate within the housing at a speed sufficient to induce vibration of the vibratory head.

In one illustrative embodiment, the speed increasing means comprises a gearbox. The gearbox may comprise a housing, a first bearing set supported in the housing, and a first gear having a diameter, the first gear mounted on the first bearing set for rotation relative to the housing. The gearbox may also comprise a second bearing set supported in the housing and a second gear having a diameter smaller than the diameter of the first gear. The second gear may be mounted on the second bearing set for rotation relative to the housing and engaged with the first gear to receive rotation transmitted therefrom. The gearbox may still further comprise a first shaft coupled to the first gear and configured to receive rotational output from the power tool, and a second shaft coupled to the second gear and configured to provide output to the input shaft of the vibratory head.

In some embodiments, the gearbox may have a ratio of about 5:1 thereby transmitting rotation to the vibratory head at a speed five times greater than the speed of the output of the power tool. In some embodiments, the gearbox may have a ratio of about 3:1. In still other embodiments, the ratio may be about 4:1.

In one illustrative embodiment, the concrete finishing tool comprises a handle, a frame coupled to the handle, and a vibrating blade coupled to the frame, wherein the power tool is coupled to the handle of the concrete finisher and the vibratory head is engaged with the vibrating blade to transfer vibration to the vibrating blade.

In some embodiments, the power tool may comprise a rotary power tool. In some embodiments, the power tool may comprise a power drill. The power drill may be battery powered.

Additional features of the present disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a diagrammatic view of a tool adapted to be powered by a power drill for performing an operation on a workpiece;

FIG. 2 is a perspective views of a concrete finishing tool including a gearbox coupled to a power drill, the gear box transmitting rotational motion from the power drill to a vibratory head;

FIG. 3 is a perspective view of a cordless power drill engaged with a gearbox;

FIG. 4 is an elevation view of a clamp connecting a smaller drill to a frame of the screed;

FIG. 5 is an elevation view of a clamp connecting a larger drill to the frame of the screed;

FIG. 6 is a perspective view showing a free-standing concrete vibrator with a gearbox coupled to a cordless power drill, the gear box transmitting rotational motion from the power drill to a vibratory head through a flexible shaft;

FIG. 7 is an elevation view of the free-standing concrete vibrator of FIG. 6;

FIG. 8 is an exploded assembly view of the gearbox of FIGS. 2, 3, 6, and 7;

FIG. 9 is a sectional view of the gearbox;

FIG. 10 is an elevation view of a cover plate of the gearbox of FIGS. 8 and 9;

FIG. 11 is an elevation view with portions cut-away of a housing and gear set of the gearbox of FIGS. 8;

FIG. 12 is a perspective view of a concrete finishing tool including an edger float coupled to a vibratory head of another embodiment of a free-standing concrete vibrator having a gearbox coupled to a cordless power drill, the gear box transmitting rotational motion from the power drill to the vibratory head through a rigid shaft;

FIG. 13 is a perspective view of the concrete finishing tool of FIG. 12 being used by an operator to consolidate an edge of an uncured concrete surface;

FIG. 14 is an exploded assembly view of the rigid shaft of the free-standing concrete vibrator of FIG. 12; and

FIG. 15 is a plan view of a portion of the rigid shaft of FIG. 12 with portions cut-away to show a cross-section of the vibratory head.

### DETAILED DESCRIPTION OF THE DRAWINGS

According to the present disclosure, a tool 10 is adapted for use with a rotary power tool, illustratively embodied as a power drill 12, to perform an operation on a workpiece 14, as shown diagrammatically, for example, in FIG. 1. Tool 10 includes a movable component 16 adapted to facilitate performance of an operation on workpiece 14 and a rotary power tool interface 18. Rotary power tool interface 18 is adapted to be coupled to and uncoupled from drill 12 and is coupled to movable component 16 to transmit power from drill 12 to movable component 16.

Illustratively, rotary power tool interface 18 comprises a mount 22 and a gearbox 24. Mount 22 is adapted to mount drill 12 to tool 10 for release therefrom. Gearbox 24 is configured to adjust the output speed of power drill 20 to a speed suitable for operation of movable component 16.

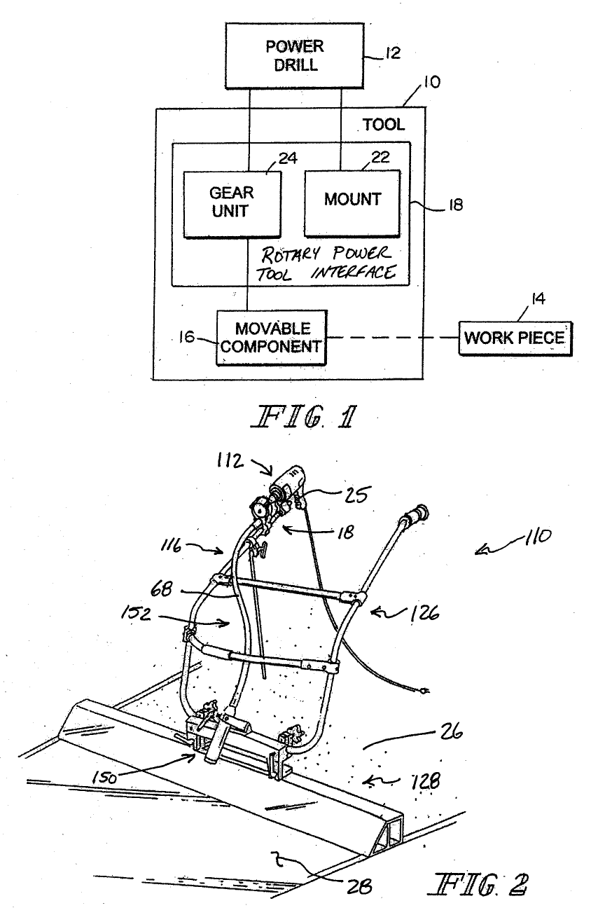

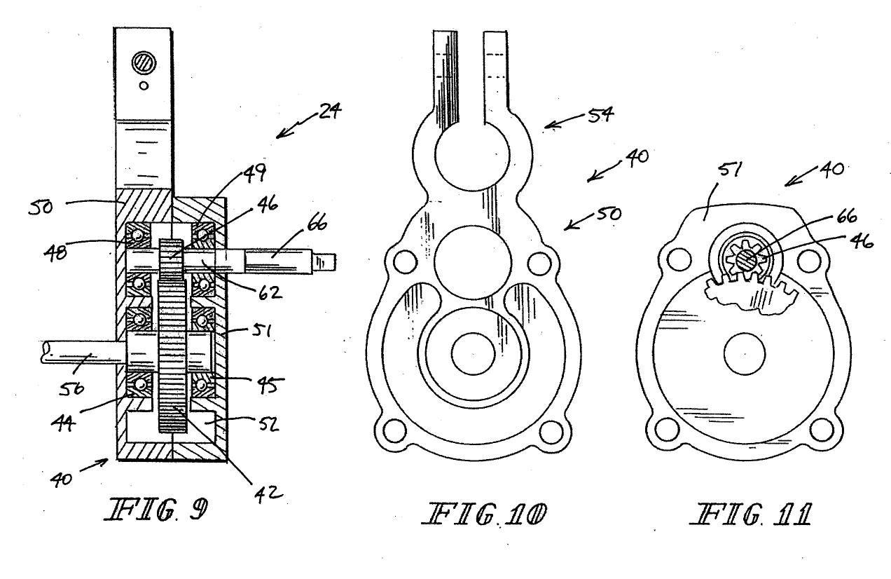

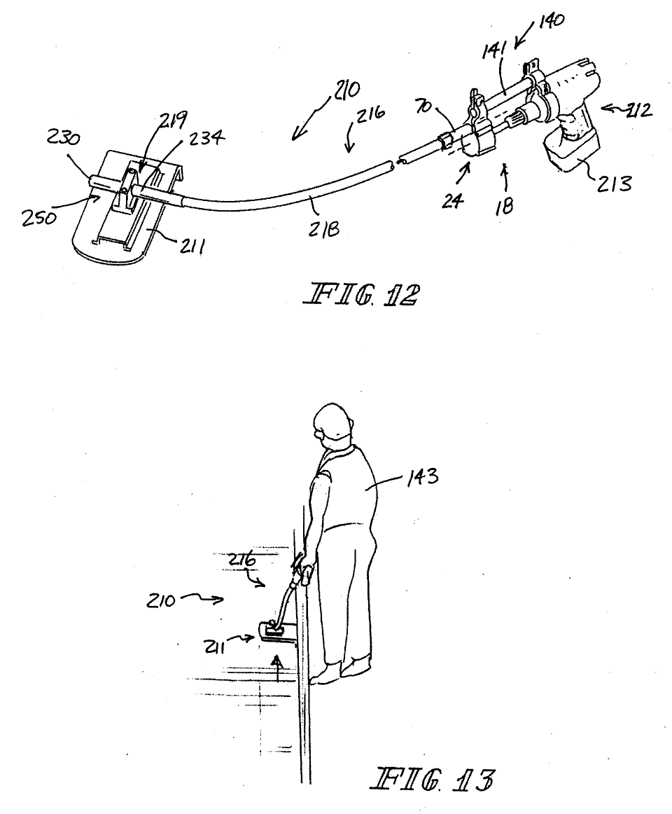

Drill 12 can thus be coupled to interface 18 to act as a power source for tool 10. Further, drill 12 can be uncoupled from tool 10 to allow use of drill 12 for another purpose or perhaps to facilitate storage of tool 10. As such, there may be a plurality of tools, each having a rotary power tool interface adapted to be coupled to drill 12 for transmitting power from drill 12 to a movable component of the associated tool. A single rotary power tool may thus be used as the power source of a plurality of tools. In the illustrative embodiment of FIG. 2, drill 12 is embodied as an AC powered electric drill 112. In the illustrative embodiments of FIGS. 3-15, drill 12 is embodied as a DC powered cordless drill 212 with a battery 213. It should be understood that drill 212 and drill 112 may be interchanged depending on the environment of use.

Tool 10 may be configured as any number of tools operable by a power source. For example, tool 10 may be a concrete-finishing tool such as, for example, a concrete screed, concrete edger, concrete groover, concrete float, or concrete consolidator. In such a case, workpiece 14 may be freshly poured or otherwise uncured concrete and movable component 16 may be a vibrator having, for example, an eccentric or other vibratory element that induces vibration of tool 10 in response to operation of drill 12 during screeding, edging, grooving, floating, consolidation, or performance of some other operation on the concrete. In other embodiments, tool 10 may be a yard tool such as, for example, a grass edger, hedge trimmer, or weed cutter. Movable component 16 may thus be configured as any of a variety of cutting elements for workpieces such as grass, bushes, weeds, or the like. Tool 10 may thus be configured to be powered by drill 12 to accomplish any of a variety of purposes.

A drill 112 may be used, for example, with a two-handle screed 110 to power vibration of a vibrator 116 of screed 110, as shown, for example, in FIGS. 2 and 3. Screed 110 includes a frame 126 coupled to a blade 128 that a person slides over the top of uncured concrete 26 to strike off extra concrete and screed the uncured to a finished surface 28. Vibrator 116 promotes such use of blade 128 and further promotes consolidation of the concrete 26. When coupled to screed 110, a handle 25 of drill 112 may act as the left or right handle of screed 110. Rotary motion from drill 112 is transferred through a flexible shaft 152 to a vibratory head 150 coupled to screed blade 128 to transfer vibration to the screed blade 128 to consolidate concrete. Flexible shaft 152 comprises a flexible casing 68 and a flexible cable 63 as shown in the illustrative embodiment of FIG. 3. Vibratory head 150 is constructed similarly to a vibratory head 250 of the illustrative embodiment of FIGS. 12-15 below with the connector 226 connecting eccentric 228 to cable 63 in the illustrative embodiments of FIGS. 1-7.

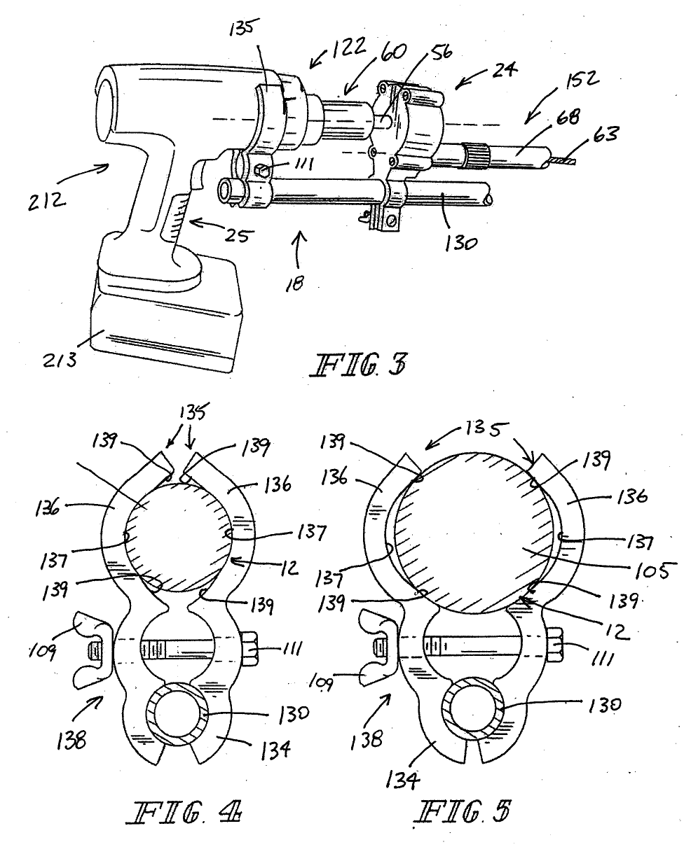

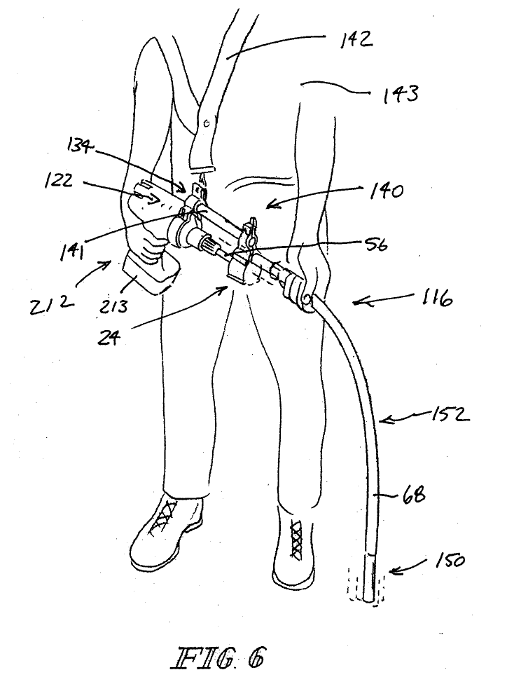

Drill interface 18 is included in screed 110 for coupling and uncoupling drill 112 to and from screed 110. In one example, shown in FIG. 3, mount 22 of interface 18 is configured as a clamp 122 coupled to a frame 130 of a U-shaped member 132 of frame 126. Clamp 122 includes two clamp members 135, each member 35 having a first portion 134 for clamping and releasing frame 130 and a second portion 136 for clamping and releasing drill 212, as shown, for example, in FIGS. 4 and 5. Second portion 136 includes opposed first surfaces 137 having a first radius for mating against an outer surface of a smaller portions of drill 212 such as housing 107 shown in FIG. 4. Second portion also includes opposed second surfaces 139 having a second radius larger than the first radius for mating against an outer surface of larger portions of a drill 212 such as a housing 105. A release 138 including a wing-nut 109 and bolt 111 is used to selectively tighten and loosen clamp portions 134, 136, as shown, for example, in FIGS. 4 and 5, by tightening wing-nut 109 on bolt 111.

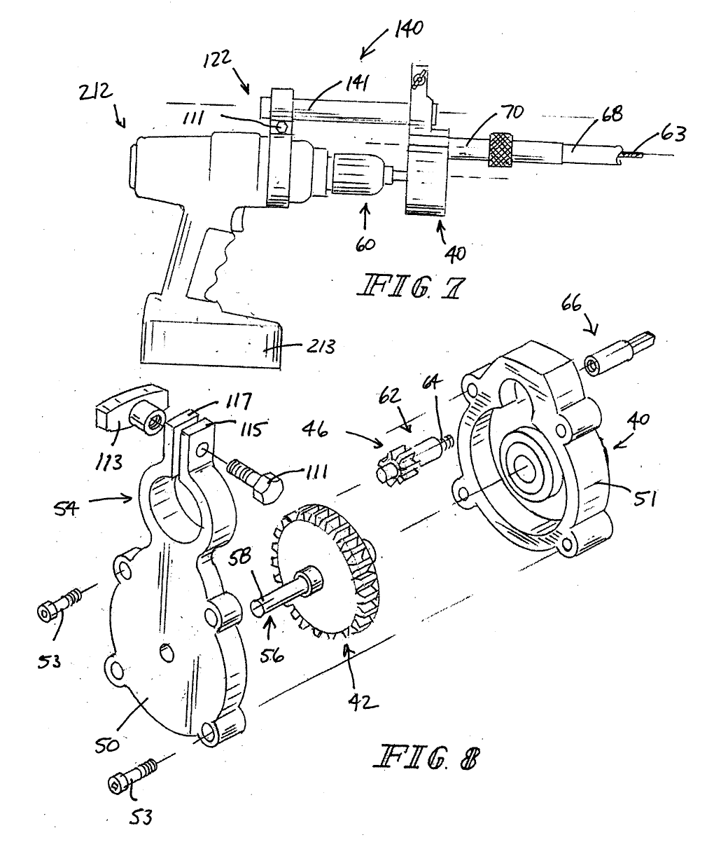

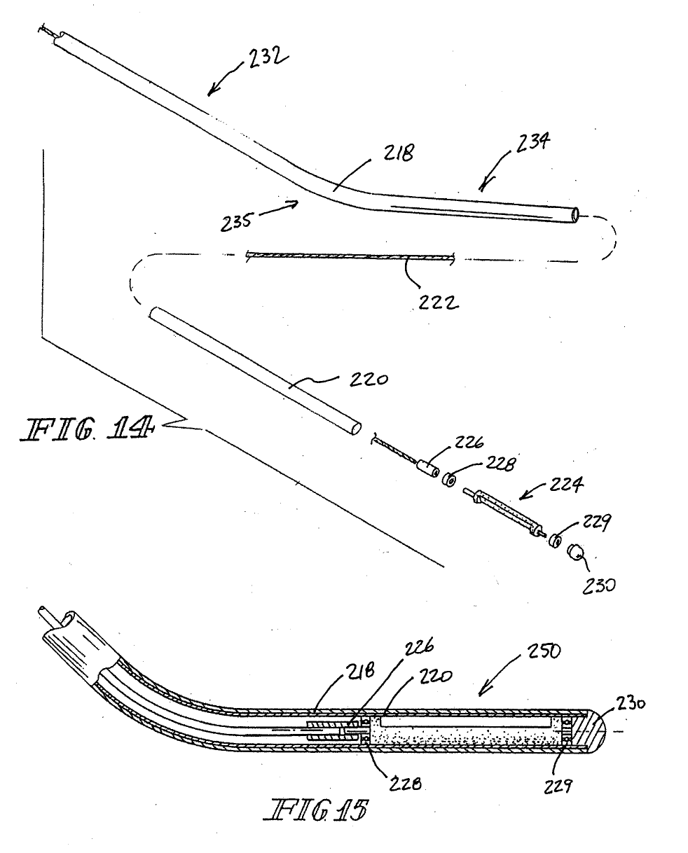

Clamp 122 may be used alone or in combination with a stabilizer 140 to provide mount 22, as shown in FIG. 6. Clamp 122 is used alone in the example of FIGS. 2 and 3. However, in the example of FIGS. 6 and 7, clamp 122 is used with stabilizer 140 to mount drill 212. Stabilizer 140 is configured, for example, as a bar 141 coupled to gearbox 24 and first clamp portion 134 of clamp 122 to stabilize the connection between drill 212 and gearbox 24. Gearbox 24 must be fixed relative to drill 112 or drill 212 to allow rotation of a rotational output, such as chuck 60 of drills 112 or 212 to be transferred to an input shaft 56 of gearbox 24. Such a mount configuration may be used with a free-standing vibrator 116, as suggested in FIG. 6, or may be used with other tools such as a concrete edger 210 shown in FIG. 13. A shoulder harness 142 for carrying the tool may be coupled to stabilizer 140 such that the tool may be supported during use by an operator 143.

Gearbox 24 connects drill 212 to vibrator 116, as shown, for example, in FIGS. 6 and 7. Exemplarily, gearbox 24 may be configured to act as a speed increaser to increase the output speed of drill 212 or a speed reducer to decrease the output speed of drill 212, depending on the particular tool application and the internal gearing 39 of drill 212. The gear ratio of gearbox 24 may be, for example, about 5:1 to increase the output speed of drill 212 by about 5. Such a gear ratio may be particularly useful with screed 110. Other tools may call for different gear ratios, such as, for example, about a 4:1 or 3:1 speed increase. A free-standing vibrator such as vibrator 116, for example, may call for only about a 3:1 speed increase.

Gearbox 24 includes a housing 40 containing a larger gear 42 mounted for rotation in two bearings 44 45 and a smaller gear 46 mounted for rotation in two bearings 48 and 49, as shown, for example, in FIGS. 8-11. Illustratively, housing 40 includes a cover 50 and a case 51 which are fastened to one another by fasteners 53 to enclose gears 42 and 46 and bearings 44, 45, 48, and 49. Bearings 44, 45, 48, and 49 are packed in lubricant in the form of, for example, grease 52 contained in housing 40. In some embodiments, bearings 44, 45, 48, and 49 may be sealed bearings and may operate in the absence of a lubricant.

Larger gear 42 receives a shaft 56 extending through bearings 44 and 45 for rotation of larger gear 42. An end portion 58 of shaft 56 is received by a chuck 60 of drill 212. Smaller gear 46 receives a shaft 62 extending through bearings 48 and 49 for rotation of smaller gear 46. An end portion 64 of shaft 62 is received by a connector 66 that connects shaft 62 to a flexible cable 63, shown in FIG. 7, extending through a flexible casing 68 of vibrator 116. Connector 66 extends through an adaptor 70 connecting casing 68 to case 51 of housing 40.

A clamp 54 is coupled to cover 50. Clamp 54 is configured to clamp frame 130 as shown in FIG. 2 or stabilizer 140 as shown in FIG. 7 depending on the particular tool configuration. Clamp 54 is tightened to clamp to frame 130 or stabilizer 140 by turning a threaded handle 113 on a bolt 111 which passes through two flanges 115 and 117 of clamp 54 which thereby urges clamp 54 to engage frame 130 or stabilizer 140 to secure gearbox 24 to the frame 130 or stabilizer 140.

A concrete edger 210 is configured to form an edge in concrete, as shown, for example, in FIGS. 13 and 14. Edger 210 includes drill interface 18 adapted to be coupled to and uncoupled from drill 212. Edger 210 includes an edger plate 211 for forming the edge in the concrete and a vibrator 216 operated by drill 212 via interface 18 and coupled to plate 211 to vibrate plate 211.

Vibrator 216 includes a single rigid outer tube 218 containing internal components responsible for generating the vibration forces transmitted to plate 211, as shown, for example, in FIGS. 15 and 16. Inclusion of various interconnecting fittings and vibration isolators can be avoided by use of single outer tube 218. Tube 218 is made, for example, of aluminum.

The internal components include a tubular liner 220. Liner 220 mates against an inner surface of outer tube 218 and contains a flexible shaft 222 for rotation therein. Liner 220 thermally insulates outer tube 218 from heat generated by frictional forces during rotation of shaft 222.

A vibratory head 250 of vibrator 216 includes an eccentric 224 is coupled to shaft 222 via a connector 226 for rotation in liner 220 with shaft 222. Eccentric 224 is mounted in liner 220 by use of two bearings 228 and 229 coupled to eccentric 224 at opposite ends thereof. An end cap 230 is coupled to an end of outer tube 218 to close the end thereof. Rotation from drill 212 is transferred to eccentric 224 to induce vibration at the vibratory head 250 which is then imparted to the plate 211.

Illustratively, outer tube 218 is bent to facilitate use of edger 210, as shown, for example, in FIG. 13. Outer tube 218 thus has a longer portion 232 and a shorter portion 234, the portions 232, 234 being separated by a bend 235 in outer tube 218. Interface 18 is coupled to longer portion 232 and eccentric 224 is mounted in shorter portion 234. Shaft 222 and liner 220 extend through both portions 232, 234.

Edger plate 211 may be replaced by a variety of other concrete-finishing elements. For example, as shown in FIGS. 17-19, edger plate may be replaced by a finishing trowel 240. A clamp 219 shown, for example, in FIG. 17 may be used to connect tube 218 to trowel 240.

Drill 212 has a variable speed control 50 in the form of, for example, a trigger coupled to handle 25. Speed control 50 is electrically coupled to a motor 52 of drill 212 to control the output speed of drill 212. A person operating drill 212 may depress control 50 to varying degrees to vary the output speed of drill 212 between different non-zero speeds.

What is claimed:

1. A concrete finishing tool comprising
a power tool including a rotational output;
a vibratory head including a vibrator case and an eccentric housed for rotation therein, the vibratory head including an input shaft; and
speed increasing means for receiving rotational output from the power tool and rotating the input shaft of the vibratory head at a speed greater than the rotational output of the power tool to cause the eccentric to rotate within the housing at a speed sufficient to induce vibration of the vibratory head.

2. The concrete finishing tool of claim 1, wherein the speed increasing means comprises a gearbox.

3. The concrete finishing tool of claim 2, wherein the power tool is a cordless drill.

4. The concrete finishing tool of claim 3, wherein the gearbox comprises (i) a housing, a first bearing set supported in the housing, (ii) a first gear having a diameter, the first gear mounted on the first bearing set for rotation relative to the housing, (iii) a second bearing set supported in the housing, (iv) a second gear having a diameter smaller than the diameter of the first gear, the second gear mounted on the second bearing set for rotation relative to the housing and engaged with the first gear to receive rotation transmitted therefrom, (v) a first shaft coupled to the first gear and configured to receive rotational output from the power tool, and (vi) a second shaft coupled to the second gear and configured to provide output to the input shaft of the vibratory head.

5. The concrete finishing tool of claim 4, further comprising a handle, a frame coupled to the handle, and a vibrating blade coupled to the frame, wherein the power tool is coupled to the handle of the concrete finisher and the vibratory head is engaged with the vibrating blade to transfer vibration to the vibrating blade.

6. The concrete finishing tool of claim 5, wherein the concrete finishing tool further comprises a flexible casing coupled to the housing of the gearbox and a flexible cable within the flexible casing, the flexible cable coupled to the second shaft to transmit rotation through the casing to the vibratory head.

7. The concrete finishing tool of claim 6, wherein the vibratory head comprises an outer housing coupled to the flexible casing, first and second bearings supporting the eccentric at first and second ends respectively, a connector connecting the flexible cable to the eccentric to transmit rotation to the eccentric to induce vibration of the vibratory head.

8. The concrete finishing tool of claim 6, wherein the power tool is battery powered.

9. The concrete finishing tool of claim 5, wherein the concrete finishing tool further comprises a rigid outer tube coupled to the housing of the gearbox and a flexible cable within the flexible casing, the flexible cable coupled to the second shaft to transmit rotation through the casing to the vibratory head.

10. The concrete finishing tool of claim 9, wherein the vibratory head comprises an outer housing coupled to the flexible casing, first and second bearings supporting the eccentric at first and second ends respectively, a connector connecting the flexible cable to the eccentric to transmit rotation to the eccentric to induce vibration of the vibratory head.

11. The concrete finishing tool of claim 10, wherein the power tool is battery powered.

12. The concrete finishing tool of claim 5, wherein the power tool is battery powered.

13. The concrete finishing tool of claim 4, wherein the power tool is battery powered.

14. A concrete finishing tool comprising
a power tool including a rotational output;
a vibratory head including a vibrator case and an eccentric housed for rotation therein, the vibratory head including an input shaft; and
a gearbox coupled to the rotational output from the power tool and rotating the input shaft of the vibratory head at a speed greater than the rotational output of the power tool to cause the eccentric to rotate within the housing at a speed sufficient to induce vibration of the vibratory head.

15. The concrete finishing tool of claim 14, wherein the power tool is a cordless drill.

16. The concrete finishing tool of claim 3, wherein the gearbox comprises (i) a housing, a first bearing set supported in the housing, (ii) a first gear having a diameter, the first gear mounted on the first bearing set for rotation relative to the housing, (iii) a second bearing set supported in the housing, (iv) a second gear having a diameter smaller than the diameter of the first gear, the second gear mounted on the second bearing set for rotation relative to the housing and engaged with the first gear to receive rotation transmitted therefrom, (v) a first shaft coupled to the first gear and configured to receive rotational output from the power tool, and (vi) a second shaft coupled to the second gear and configured to provide output to the input shaft of the vibratory head.

17. The concrete finishing tool of claim 16, further comprising a handle, a frame coupled to the handle, and a vibrating blade coupled to the frame, wherein the power tool is coupled to the handle of the concrete finisher and the vibratory head is engaged with the vibrating blade to transfer vibration to the vibrating blade.

18. The concrete finishing tool of claim 17, wherein the concrete finishing tool further comprises a flexible casing coupled to the housing of the gearbox and a flexible cable within the flexible casing, the flexible cable coupled to the second shaft to transmit rotation through the casing to the vibratory head.

19. The concrete finishing tool of claim 18, wherein the vibratory head comprises an outer housing coupled to the flexible casing, first and second bearings supporting the eccentric at first and second ends respectively, a connector connecting the flexible cable to the eccentric to transmit rotation to the eccentric to induce vibration of the vibratory head.

20. The concrete finishing tool of claim 18, wherein the power tool is battery powered.

21. The concrete finishing tool of claim 17, wherein the concrete finishing tool further comprises a rigid outer tube coupled to the housing of the gearbox and a flexible cable within the flexible casing, the flexible cable coupled to the second shaft to transmit rotation through the casing to the vibratory head.

22. The concrete finishing tool of claim 21, wherein the vibratory head comprises an outer housing coupled to the flexible casing, first and second bearings supporting the eccentric at first and second ends respectively, a connector connecting the flexible cable to the eccentric to transmit rotation to the eccentric to induce vibration of the vibratory head.

23. The concrete finishing tool of claim 22, wherein the power tool is battery powered.

24. The concrete finishing tool of claim 17, wherein the power tool is battery powered.

25. The concrete finishing tool of claim 16, wherein the power tool is battery powered.

26. A gearbox for a concrete finishing tool including a power tool having a rotational output; a vibratory head having a vibrator case and an eccentric housed for rotation therein, the vibratory head also having an input shaft, the gearbox comprising
a housing;
a first bearing set supported in the housing;
a first gear having a diameter, the first gear mounted on the first bearing set for rotation relative to the housing;
a second bearing set supported in the housing;
a second gear having a diameter smaller than the diameter of the first gear, the second gear mounted on the second bearing set for rotation relative to the housing and engaged with the first gear to receive rotation transmitted therefrom;
a first shaft coupled to the first gear and configured to receive rotational output from the power tool; and
a second shaft coupled to the second gear and configured to provide output to the input shaft of the vibratory head.
